(19) United States
(12) Patent Application Publication
(10) Pub. No.: US 2023/0208141 A1
(43) Pub. Date: Jun. 29, 2023

(54) CONTROL SYSTEM AND METHOD FOR USING ENERGY STORAGE IN CONTRACT CAPACITY USERS

(71) Applicant: NATIONAL CHUNG SHAN INSTITUTE OF SCIENCE AND TECHNOLOGY, Taoyuan City (TW)

(72) Inventors: CHENG-YU SHIH, Taoyuan City (TW); SHU-HSIEN WEN, Taoyuan City (TW); CHIH-HSIEN CHUNG, Taoyuan City (TW); SHIH-CHANG TSENG, Taoyuan City (TW); GWO-HUEI YOU, Taoyuan City (TW); KUO-KUANG JEN, Taoyuan City (TW)

(21) Appl. No.: 17/564,247

(22) Filed: Dec. 29, 2021

(51) Int. Cl. H02J 3/32; H02J 3/00

(52) U.S. Cl. CPC H02J 3/32; H02J 3/003

(57) ABSTRACT

A control method for using a battery for energy storage for contract capacity users includes, turning on a demand controller, starting output power calculation and battery power supply control, measuring a power consumption time interval set by a utility company as a cycle time, obtaining a power value that a load can use every minute, measuring and calculating an output power of a utility power output once a minute, and accumulating the output power according to time and comparing it with an accumulative usable contract capacity. When accumulative output power of the utility power output is greater than accumulative usable contract capacity and voltage of the battery is higher than a preset lower limit, start the battery to supply power to the load and when the voltage of the battery is lower than the preset lower limit, the battery will not supply power to the load.

### BACKGROUND OF THE INVENTION

### 1. Field of the Invention

The present disclosure relates to energy supply systems, and in particular to a system and method for applying energy storage to contract capacity users, which can effectively prevent power users from exceeding their contracts and thereby save money on electricity bills.

### 2. Description of the Related Art

Today's companies, factories, retail stores, and other power users with high demand for electricity usually sign contracts with power companies, requiring instant power (i.e., instant demand) or total electricity consumption restrictions. If it exceeds a certain fixed value, the industry will need to pay additional punitive electricity charges, which is the so-called contract capacity.

According to the technical regulations of typical power companies, when the user's electricity consumption exceeds 10% of the contract capacity, the electricity bill is doubled, and when it exceeds 10% of the contract capacity, the electricity bill is tripled. In view of this, how to effectively control and maintain power consumption within the contracted capacity has become an important cost-saving topic.

The prior art includes that when it is predicted that the total power consumption in the next time period may exceed the contract capacity, the operating status of the electronic equipment can be adjusted in real time to reduce the total power consumption and prevent the total power consumption in the next time period from exceeding the contract capacity.

For example, a conventional intelligent power saving method is set between a mains power terminal and at least one load terminal. This smart power saving method includes the following steps. First, a power monitor is set between the mains power terminal and the load terminal and monitors at least one energy storage device. The power monitor is connected to the mains power supply terminal and the energy storage device. Then, the power monitor selects whether the energy storage device supplies power to the load according to the power consumption.

Another conventional intelligent power management system and method thereof includes a detection module, a processing module, and a monitoring module. The detection module includes a plurality of recording units and a plurality of node control units. The processing module includes an analysis unit and a scheduling unit. The monitoring module includes a management unit. The intelligent power management method includes the recording unit separately records the predetermined power consumption of the corresponding device, and the node control unit counts the power consumption of the device, and when the analysis unit determines that the sum of the predetermined power consumption of the device reaches a contract capacity value the management unit controls the node control unit to adjust the use of the device accordingly to control electricity status, audit to confirm electricity consumption status, and prevent electricity consumption from exceeding the contract.

Another conventional demand response service system control method integrates thousands of electricity users to improve the efficiency of demand response. This demand response service system control method includes the following steps: receive demand response commands; determine the user, area, and demand of the demand response commands; determine whether the load in the area meets the demand response commands; if not, judge whether to use an energy storage system; and if it is determined to use an energy storage system, send participation in demand response events and adjust the load.

However, these conventional methods are not adequate to prevent power users from exceeding their contracts.

Thus, it is desirable to have improvements on the conventional methods to prevent power users from exceeding their contracts and thereby save money from lower electricity bills.

### BRIEF SUMMARY OF THE INVENTION

An objective of the present disclosure is to provide a control system and method for using energy storage with contract capacity users.

To achieve at least the above objective, the present disclosure provides a system and method for applying energy storage to contract capacity users, which can effectively prevent power users from exceeding their contracts and save electricity bills. The present disclosure provides a control system and method for using energy storage with contract capacity users. The system includes a current sensor connected to the mains and the load (user terminal) for sensing the current delivered by the mains to the load; an inverter, connected to the power supply circuit, energy storage module (battery) and a controller of the mains power supply terminal and the load terminal. The energy storage module outputs the electric energy of the battery to the load through the inverter. The controller is used to determine whether or not the battery module supplies power to the load side.

The present disclosure also provides a control method for using energy storage for contract capacity users. The control system using energy storage for contract capacity users is set between a mains power supply terminal and at least one load terminal. The control method includes the following steps: first turn on the demand controller. Then determine whether the battery voltage is lower than a preset upper limit value. When the battery voltage is lower than a preset upper limit value and the load power consumption is lower than the preset demand consumption, the mains power supply charges the battery to the preset value. When the upper limit preset, stop charging the battery. Then, start output power calculation and battery power supply control, according to the power company's setting to measure the contract capacity user's power consumption time interval as the cycle time, and divide the cycle time contract capacity by the cycle time (n minutes) to get the power that can be used by the load per minute. Then measure and calculate the output power of the mains power output once a minute, accumulate the output power according to time and compare it with the accumulative usable contract capacity. When the accumulative output power of the mains output is greater than the accumulative available (when the contract capacity is used) and the battery voltage is higher than a preset lower limit, the battery is started to supply power to the load. If the battery voltage is lower than a preset lower limit, the battery does not supply power.

To achieve at least the above objectives, the present disclosure provides a system and method for applying energy storage to contract capacity to prevent users from exceeding their contracts, as exemplified in any one of the above embodiments.

### BRIEF DESCRIPTION OF THE DRAWINGS

FIG. 1 is a schematic diagram illustrating a system architecture diagram of the technology of the present disclosure.

FIG. 2 is a flow chart illustrating a method for applying energy storage to contract capacity to prevent users from exceeding their contracts according to an embodiment of the present disclosure.

FIG. 3 is a flow chart illustrating a method for applying energy storage to contract capacity to prevent users from exceeding their contracts according to an embodiment of the present disclosure.

FIG. 4 is a flow chart illustrating a method for applying energy storage to contract capacity to prevent users from exceeding their contracts according to an embodiment of the present disclosure.

FIG. 5 is a flow chart illustrating a method for applying energy storage to contract capacity to prevent users from exceeding their contracts according to an embodiment of the present disclosure.

FIG. 6 is a flow chart illustrating a method for applying energy storage to contract capacity to prevent users from exceeding their contracts according to an embodiment of the present disclosure.

FIG. 7 is a drawing illustrating calculation of technical output power according to an embodiment of the present disclosure.

FIG. 8 is a flow chart illustrating a method for applying energy storage to contract capacity to prevent users from exceeding their contracts according to an embodiment of the present disclosure.

FIG. 9 is a graph illustrating predicting when power output will exceed the contract.

FIG. 10 is a graph illustrating predicting that the consumption will not exceed the contract.

FIG. 11 is a graph illustrating maintaining demand below limit.

FIG. 12 is a graph illustrating actual operation results.

### DETAILED DESCRIPTION OF THE INVENTION

To facilitate understanding of the object, characteristics and effects of this present disclosure, embodiments together with the attached drawings for the detailed description of the present disclosure are provided.

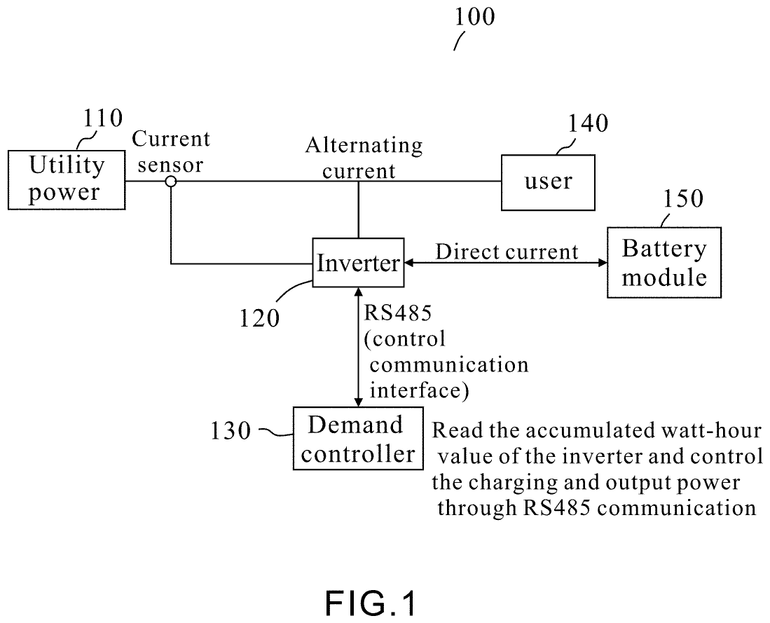

Referring to FIG. 1, which is a schematic diagram illustrating a system architecture diagram of the technology of the present disclosure.

As shown in FIG. 1, the system architecture 100 comprises a utility power supply 110 which supplies power to a user 140. A current sensor is connected between the utility power supply 110 and the user 140. An input to an inverter 120 is connected to the current sensor. A control communication interface, for example an RS485 interface, connects a demand controller 130 to the inverter 120. The control communication interface allows the accumulated watt-hour value of the inverter to be read and control the charging and output power through the control communication interface.

A battery module 150 outputs direct current (DC) to the inverter 120 when required.

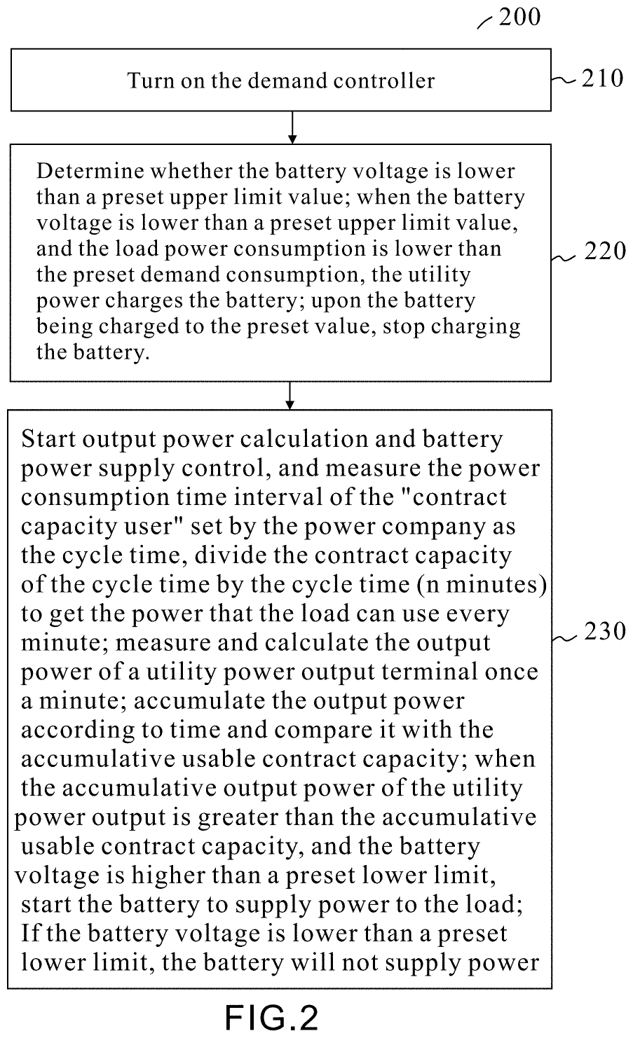

Refer to FIG. 2 is a flow chart illustrating a method for applying energy storage to contract capacity to prevent users from exceeding their contracts according to an embodiment of the present disclosure.

The method 200 begins in step 210 by turning on the demand controller. Next, in step 220, determine whether the battery voltage is lower than a preset upper limit value; when the battery voltage is lower than a preset upper limit value, and the load power consumption is lower than the preset demand consumption, the utility power charges the battery; upon the battery being charged to the preset value, stop charging the battery.

In step 230, start output power calculation and battery power supply control, and measure the power consumption time interval of the “contract capacity user” set by the power company as the cycle time, divide the contract capacity of the cycle time by the cycle time (n minutes) to get the power that the load can use every minute; measure and calculate the output power of a utility power output terminal once a minute; accumulate the output power according to time and compare it with the accumulative usable contract capacity; when the accumulative output power of the utility power output is greater than the accumulative usable contract capacity, and the battery voltage is higher than a preset lower limit, start the battery to supply power to the load; If the battery voltage is lower than a preset lower limit, the battery will not supply power

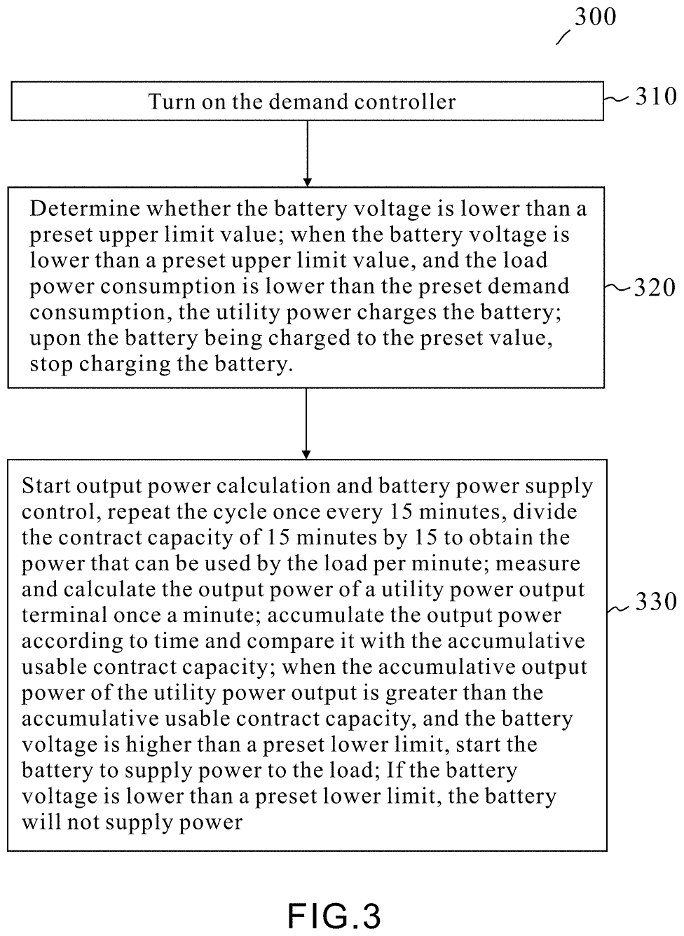

Refer to FIG. 3, which is a flow chart illustrating a method for applying energy storage to contract capacity to prevent users from exceeding their contracts according to an embodiment of the present disclosure.

The method 300 begins in step 310 by turning on the demand controller. Then, in step 320, determine whether the battery voltage is lower than a preset upper limit value; when the battery voltage is lower than a preset upper limit value, and the load power consumption is lower than the preset demand consumption, the utility power charges the battery; upon the battery being charged to the preset value, stop charging the battery.

In step 330, start output power calculation and battery power supply control, repeat the cycle once every 15 minutes, divide the contract capacity of 15 minutes by 15 to obtain the power that can be used by the load per minute; measure and calculate the output power of a utility power output terminal once a minute; accumulate the output power according to time and compare it with the accumulative usable contract capacity; when the accumulative output power of the utility power output is greater than the accumulative usable contract capacity, and the battery voltage is higher than a preset lower limit, start the battery to supply power to the load; If the battery voltage is lower than a preset lower limit, the battery will not supply power.

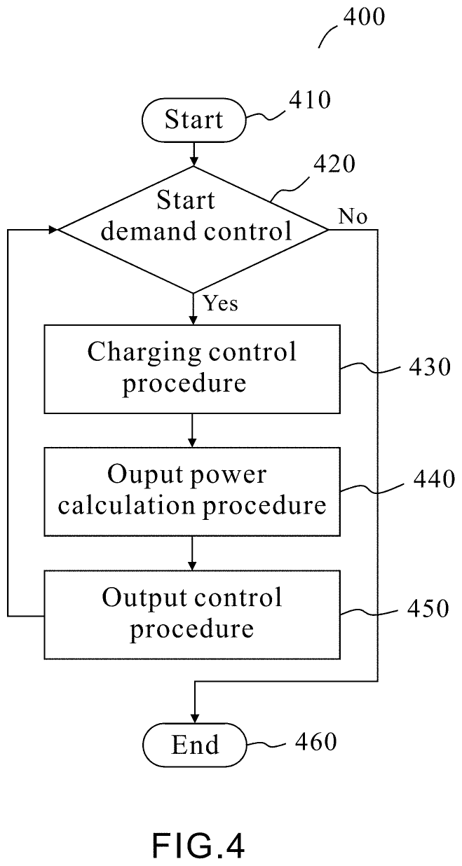

Refer to FIG. 4, which is a flow chart illustrating a method for applying energy storage to contract capacity to prevent users from exceeding their contracts according to an embodiment of the present disclosure.

As shown in FIG. 4, the method 400 begins in step 410. In step 420, determine whether or not demand control is started. If no, the method ends in step 460, if yes proceed to step 430.

In step 430 the charging control procedure is performed. Then, in step 440, the output power calculation procedure is performed. In step 450, the output control procedure is performed and the method returns to step 420 to repeat until the method 400 ends in step 460.

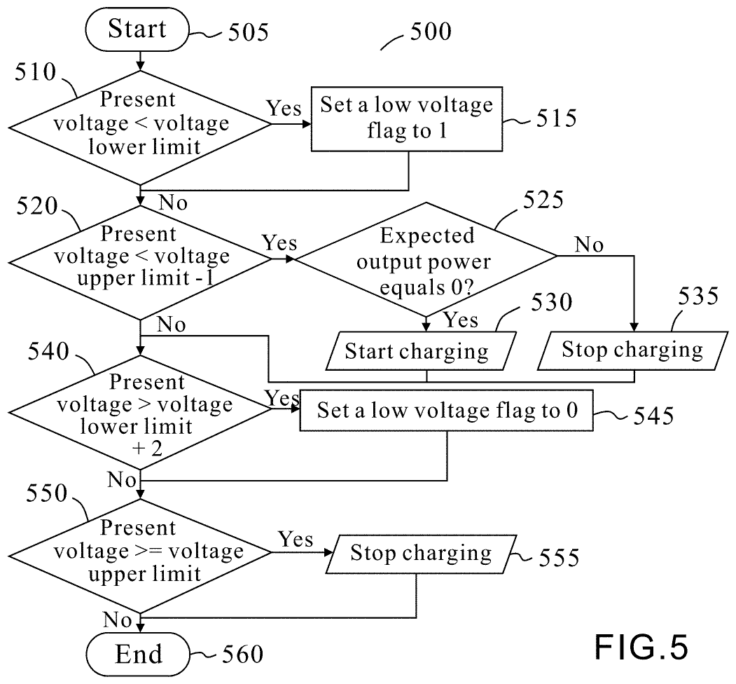

Refer to FIG. 5, which is a flow chart illustrating a method for applying energy storage to contract capacity to prevent users from exceeding their contracts according to an embodiment of the present disclosure.

As shown in FIG. 5, the method 500 starts in step 505. In step 510, determine whether or not the present voltage is less than the voltage lower limit. If yes, proceed to step 515 to set a low voltage flag to 1 and proceed to step 520. If no, proceed to step 520.

In step 520 determine whether or not the present voltage is less than the voltage upper limit minus one (−1). If yes, proceed to step 525. If no, proceed to step 540.

In step 525, determine whether or not the expected output power equals zero (0). If no, proceed to step 535. If yes, proceed to step 530.

In step 530, start charging and then proceed to step 540.

In step 535, stop charging and then proceed to step 540.

In step 540, determine whether or not the present voltage is greater than the voltage lower limit plus 2 (+2). If yes, proceed to step 545 and set a low voltage flag to zero (0) and proceed to step 550. If no, proceed to step 550.

In step 550, determine whether or not the present voltage is greater to or equal to (>=) the voltage upper limit. If yes, proceed to step 555 to stop charging and proceed to step 560 to end the method 500. If no, proceed to step 560 to end the method 500.

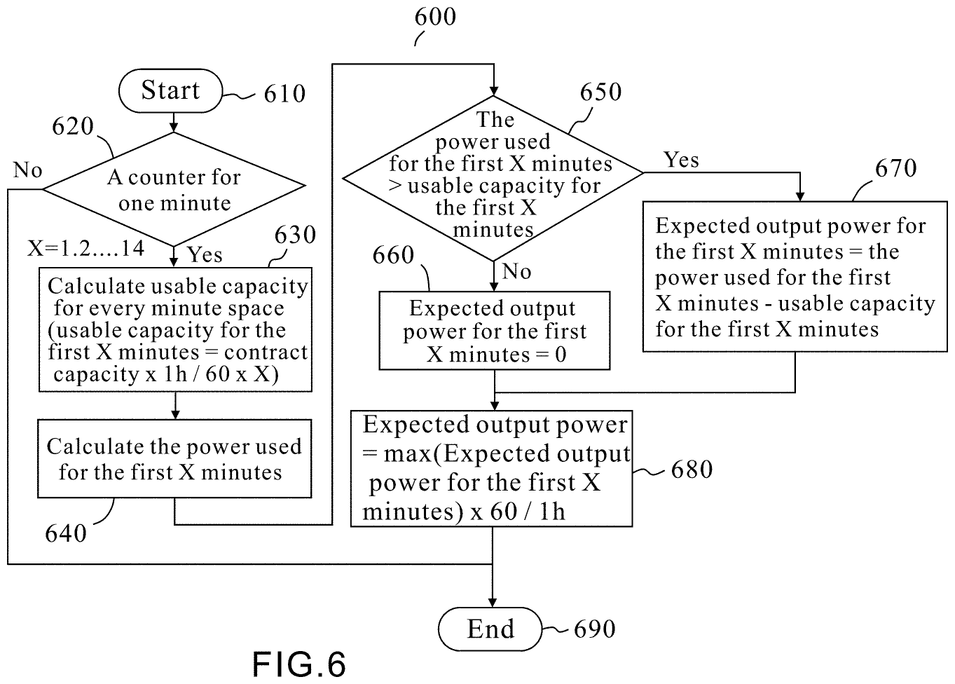

Refer to FIG. 6, which is a flow chart illustrating a method for applying energy storage to contract capacity to prevent users from exceeding their contracts according to an embodiment of the present disclosure.

As shown in FIG. 6, the method 600 starts in step 610. In step 620, determine whether or not a counter has counted for one minute. If yes, proceed to step 630. If no, proceed to step 690 to end the method 600.

In step 630, calculate the usable capacity for every minute wherein the usable capacity for the first X minutes equals the contract capacity multiplied by one hour divided by 60 multiplied by X (first X minutes=contract capacity×1 h/60×X).

In step 640, calculate the power used for the first X minutes.

In step 650, determine whether or not the power used for the first X minutes is greater than the usable capacity for the first X minutes. If yes, proceed to step 670 and set expected output power for the first X minutes equal to the power used for the first X minutes minus the usable capacity for the first X minutes and proceed to step 680.

If no, proceed to step 680.

In step 680, set the expected output power equal to the maximum expected output power for the first X minutes times 60 divided by 1 hour and proceed to step 690 to end the method 600.

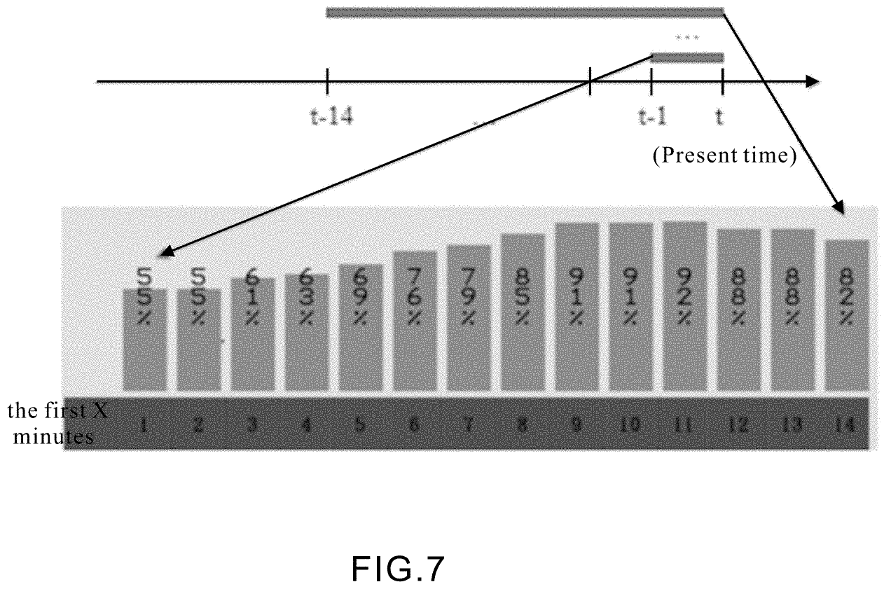

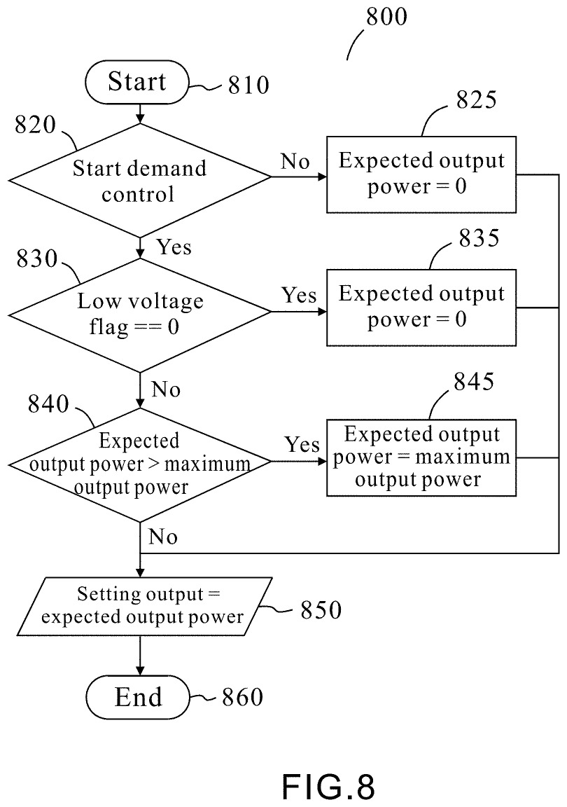

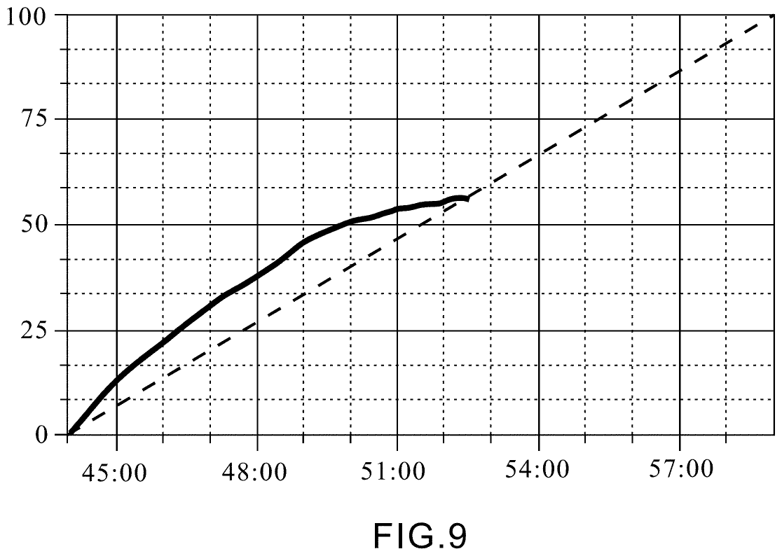

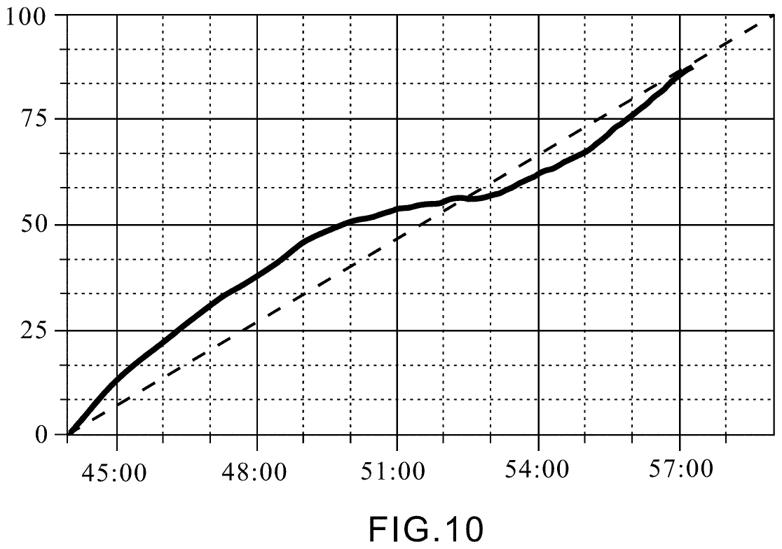

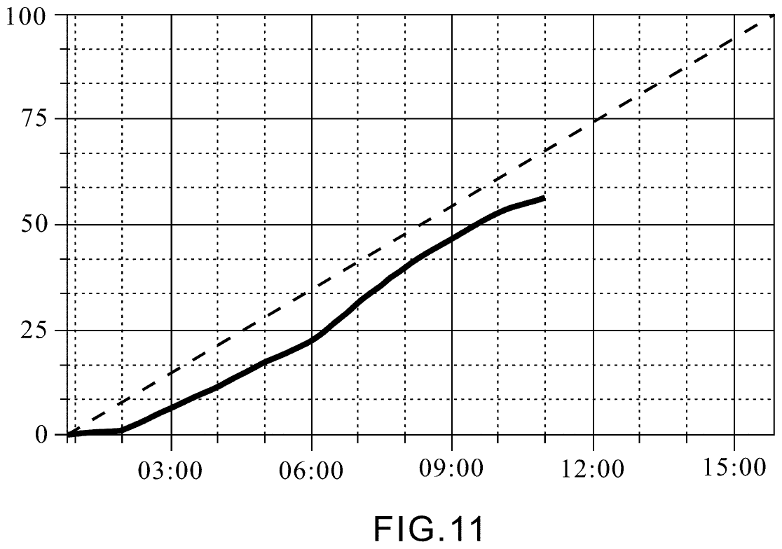

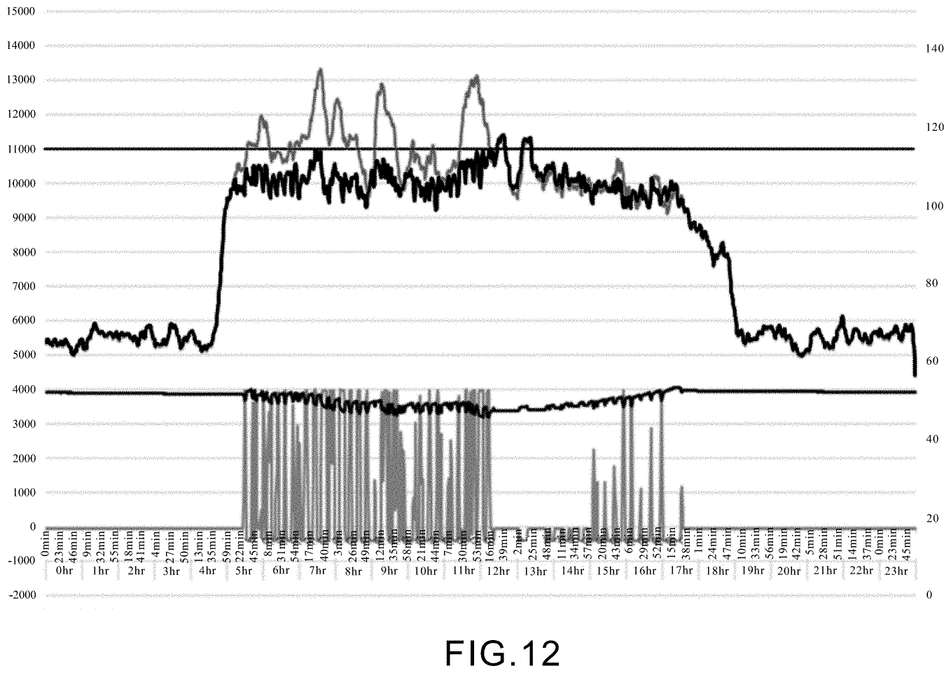

Refer to FIG. 7, which is a drawing illustrating calculation of technical output power according to an embodiment of the present disclosure, to FIG. 8, which is a flow chart illustrating a method for applying energy storage to contract capacity to prevent users from exceeding their contracts according to an embodiment of the present disclosure, to FIG. 9, which is a graph illustrating predicting when power output will exceed the contract, to FIG. 10, which is a graph illustrating predicting that the consumption will not exceed the contract, to FIG. 11, which is a graph illustrating maintaining demand below limit, and to FIG. 12, which is a graph illustrating actual operation results.

In an embodiment of the present disclosure, the method uses a cycle every 15 minutes to divide the contract capacity of 15 minutes by 15 to obtain the amount of electricity that can be used by the load per minute. The output power of the mains output terminal is measured and calculated once every minute, according to time and the cumulative output power is compared with the cumulative available contract capacity. When the cumulative output power of the mains output is greater than the cumulative available contract capacity and the battery voltage is higher than a preset lower limit, the battery will be activated to supply power to the load. When the voltage is lower than a preset lower limit, the battery does not supply power.

When the system starts, a prediction is made to determine if the power output will exceed the contract. After the power is output, it is determined that the consumption will exceed the contract and the power output is reduced and the demanded power is maintained below the limit.

While the present disclosure has been described by means of specific embodiments, numerous modifications and variations could be made thereto by those skilled in the art without departing from the scope and spirit of the present disclosure set forth in the claims.

What is claimed is:

1. A control method for using a battery for energy storage for contract capacity users comprising:
turning on a demand controller;
starting output power calculation and battery power supply control;
measuring a power consumption time interval of a user set by a utility power company as a cycle time;
dividing a contract capacity by the cycle time to get a power value that a load can use;
measuring and calculating an output power of a utility power output; and
accumulating the output power according to time and comparing it with an accumulative usable contract capacity to determine when the batter should supply power to the load.

2. The control method for using a battery for energy storage for contract capacity users according to claim 1, further comprising:
determining if a battery voltage is lower than a preset upper limit value.

3. The control method for using a battery for energy storage for contract capacity users according to claim 2, further comprising:
charging the battery if the battery voltage is lower than the preset upper limit value and a load power consumption is lower than a preset demand consumption.

4. The control method for using a battery for energy storage for contract capacity users according to claim 3, further comprising:
charging the battery to the preset upper limit value.

5. The control method for using a battery for energy storage for contract capacity users according to claim 4, further comprising:
ending charging when the preset upper limit value is reached.

6. The control method for using a battery for energy storage for contract capacity users according to claim 1, wherein when accumulative output power of the utility power output is greater than accumulative usable contract capacity, and voltage of the battery is higher than a preset lower limit, start the battery to supply power to the load.

7. The control method for using a battery for energy storage for contract capacity users according to claim 1, wherein, when the voltage of the battery is lower than the preset lower limit, the battery will not supply power to the load.

8. The control method for using a battery for energy storage for contract capacity users according to claim 1, wherein measuring and calculating the output power of the utility power output is performed once per minute.

9. A control method for using a battery for energy storage for contract capacity users comprising:
turning on a demand controller;
determining if a battery voltage is lower than a preset upper limit value;
charging the battery if the battery voltage is lower than the preset upper limit value and a load power consumption is lower than a preset demand consumption;
charging the battery to the preset upper limit value;
ending charging when the preset upper limit value is reached;
starting output power calculation and battery power supply control;
measuring a power consumption time interval of a user set by a utility power company as a cycle time;
dividing a contract capacity of the cycle time by the cycle time to get a power value that a load can use every minute; and
measuring and calculating an output power of a utility power output; and
accumulating the output power according to time and comparing it with an accumulative usable contract capacity to determine if the battery should supply power to the load.

10. The control method for using a battery for energy storage for contract capacity users according to claim 9, wherein when accumulative output power of the utility power output is greater than accumulative usable contract capacity, and voltage of the battery is higher than a preset lower limit, start the battery to supply power to the load.

11. The control method for using a battery for energy storage for contract capacity users according to claim 10, wherein, when the voltage of the battery is lower than the preset lower limit, the battery will not supply power to the load.

12. The control method for using a battery for energy storage for contract capacity users according to claim 9, wherein measuring and calculating the output power of the utility power output is performed once per minute.

13. A control method for using a battery for energy storage for contract capacity users comprising:
turning on a demand controller;
determining if a battery voltage is lower than a preset upper limit value;
charging the battery if the battery voltage is lower than the preset upper limit value and a load power consumption is lower than a preset demand consumption;
charging the battery to the preset upper limit value;
ending charging when the preset upper limit value is reached;
starting output power calculation and battery power supply control;
measuring a power consumption time interval of a user set by a utility power company as a cycle time;
dividing a contract capacity of the cycle time by the cycle time (n minutes) to get a power value that a load can use every minute; and
measuring and calculating an output power of a utility power output once a minute;
accumulating the output power according to time and comparing it with an accumulative usable contract capacity;
wherein when accumulative output power of the utility power output is greater than accumulative usable contract capacity, and voltage of the battery is higher than a preset lower limit, start the battery to supply power to the load; and
wherein, when the voltage of the battery is lower than the preset lower limit, the battery will not supply power to the load.
